(19) United States
(12) Patent Application Publication
(10) Pub. No.: US 2011/0299947 A1
(43) Pub. Date: Dec. 8, 2011

(54) CUTTING TOOL WITH RADIAL CUTTING EDGES

(75) Inventor: Jan-Willem Van Iperen, Lottum (NL)

(73) Assignee: Seco Tools AB

(21) Appl. No.: 13/202,792

(22) PCT Filed: Mar. 1, 2010
(86) PCT No.: PCT/SE2010/050236

§ 371 Date: Aug. 29, 2011

(30) Foreign Application Priority Data
Mar. 9, 2009 (SE) 0950135.4

(51) Int. Cl. B23C 5/10

(52) U.S. Cl. 407/53

(57) ABSTRACT

A cutting tool includes a body having a working end and a plurality of cutting edges at the working end of the body. Each cutting edge includes a radial cutting edge component. Each radial cutting edge component is oriented at an angle to a radius extending from an axis of rotation of the tool.

The present invention relates generally to cutting tools.

In conventional cutting tools, cutting edges are disposed at a working end of the cutting tool and are oriented along radii extending from the axis of rotation of the tool. These tools tend to form chips perpendicular to the rake face proximate the cutting edge, and the chips are forced into a chip room between successive cutting edges. The chip room is limited by the number of teeth or flutes on the tool. With too many teeth, the chip room becomes too small and the chips get clogged in the chip room. It is desirable to provide a cutting tool that facilitates removal of chips from the chip rooms of the cutting tool.

According to an aspect of the present invention, a cutting tool comprises a body having a working end and a plurality of cutting edges at the working end of the body. Each cutting edge comprises a radial cutting edge component. Each radial cutting edge component is oriented at an angle to a radius extending from an axis of rotation of the tool.

### BRIEF DESCRIPTION OF THE DRAWINGS

The features and advantages of the present invention are well understood by reading the following detailed description in conjunction with the drawings in which like numerals indicate similar elements and in which:

FIG. 1 is a side, partially cross-sectional, view of a cutting tool according to an embodiment of the present invention;

FIG. 2 is a bottom view of a cutting tool according to an embodiment of the present invention;

FIG. 3. is a side, partially cross-sectional view of the cutting tool of FIG. 2 taken at section 3-3;

FIG. 4 is a view of a portion of a cutting edge of a cutting tool according to an aspect of the present invention;

FIG. 5 is a cross-sectional view of a portion of a cutting edge of a cutting tool according to an aspect of the present invention; and

FIG. 6 is a schematic, end view of a cutting tool according to an aspect of the present invention.

### DETAILED DESCRIPTION

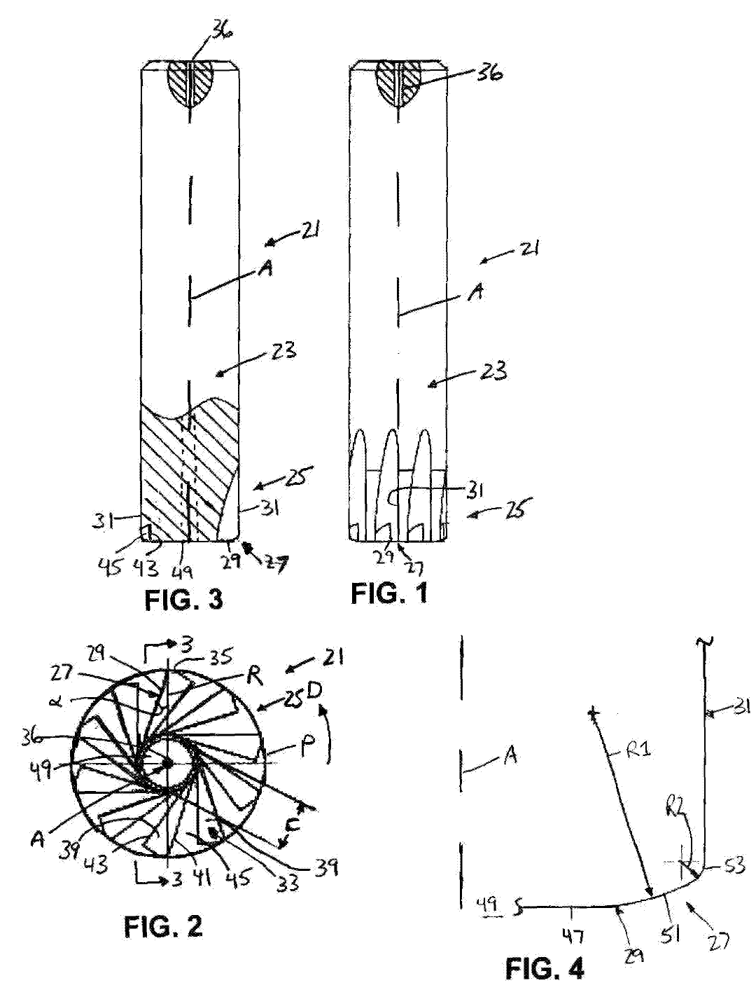

FIG. 1 shows a cutting tool 21 comprising a body 23 having a working end 25 and a plurality of cutting edges 27 at the working end of the body. As seen in FIG. 2, each cutting edge 27 comprises a radial cutting edge component 29 oriented at an angle α to a radius R extending from an axis of rotation A of the body 23, and, as seen in, for example, FIGS. 3 and 4, an axial cutting edge component 31 extending generally in the direction of the axis of rotation of the body. In the embodiment of FIGS. 1-4, the cutting edges 27 are integrally formed with the body 23, such as in the form of a cutting tool formed of a pressed and sintered cemented carbide, however, the cutting edges may be formed as parts of removable and/or indexable cutting inserts (not shown) attached to a toolholder body.

As seen in FIG. 2, each radial cutting edge component 29 intersects with a corresponding radius Rat a circumferential periphery P of the cutting tool 21. Each radial cutting edge component 29 leads its corresponding radius R in a direction D of rotation of the cutting tool 21. In this way, chips formed from the workpiece tend to be formed outside the space between successive teeth or cutting edges so chip room between the cutting edges does not limit the size of the chip. In addition, the orientation of the radial cutting edge components 29 in this fashion tends to force chips outward toward the periphery P of the cutting tool 21, where they can flow through spaces 33 between successive axial cutting edge components 31 of the cutting edges 27 for removal from the cutting site. While the spaces 33 can have helical shapes, the spaces in the embodiment shown in FIG. 1 have a 0° helix.

In the embodiment of FIG. 2, each cutting edge 27 is straight when viewed along an axis A of the cutting tool 21, i.e., the radial cutting edge component 29—the only visible part of the cutting edge—is straight when viewed along the axis A of the cutting tool. Straight lines that extend along each cutting edge 27 are each tangent to a common circle C, and an interior part 49 of the working end 25 generally outlined by the interior ends of the cutting edges and can extend to a forwardmost part of the working end as shown in FIG. 3, or can be depressed relative to the interior ends of the cutting edges. A passage 36 can extend through the cutting tool to the interior part 49, such as for providing cooling or lubricating fluid.

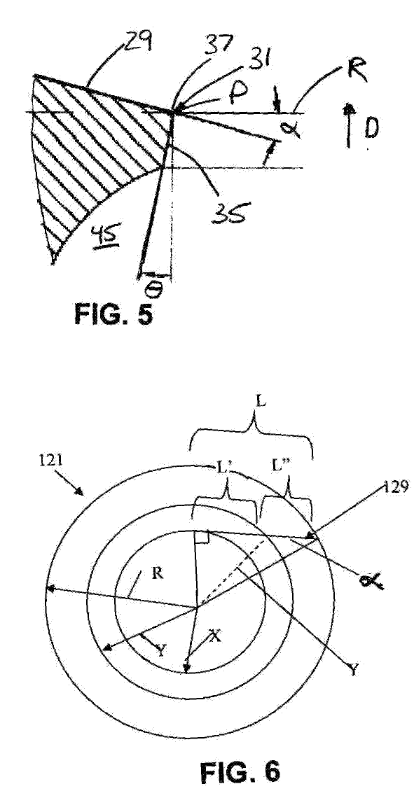

As seen in FIG. 5, an axial clearance surface 35 follows at least a part 37 of each axial cutting edge component 31 in a direction D of rotation of the cutting tool 21. For each cutting edge 27, the axial clearance surface 35 is non-perpendicular to the radius R corresponding to the radial cutting edge component 29 of the cutting edge, and is non-perpendicular to the radial cutting edge component. In the embodiment shown in FIG. 5, the axial clearance surface 35 forms an angle ⊖ of approximately 1° with the perpendicular to the radial cutting edge component 29. A radial clearance surface 39 ordinarily also follows at least a part 41 of each radial cutting edge component 29 in a direction of rotation D of the cutting tool. As seen in FIG. 2, the radial clearance surface 39 is ordinarily generally triangular in shape with a trailing edge 43 preceding a chip room 45 which precedes the next cutting edge 27. The chip room 45 will ordinarily be substantially depressed relative to the radial clearance surface 39 to facilitate formation of chips.

It will be understood that the radial clearance surface 39 and the axial clearance surface 35 ordinarily merge into one another. Similarly, the radial cutting edge component 29 and the axial cutting edge component 31 ordinarily merge into one another. As seen in FIG. 4, the radial cutting edge component 29 can be considered to be the portion of the cutting edge 27 extending up to the circumferential periphery P of the cutting tool 21, and the axial cutting edge component 31 can be considered to be the portion of the cutting edge that extends along the periphery. The radial cutting edge component 29 can be curved, such as with a radius, to merge smoothly into the axial cutting edge component 31. The radial cutting edge component 29 can also comprise other radii R2 or straight sections. The embodiment shown in FIG. 4 shows a cutting edge 27 viewed in a direction perpendicular to the cutting edge and perpendicular to the axis of rotation A wherein the cutting edge comprises a straight section 47 that extends from the interior part 49 of the tool 21 toward the outer periphery P generally perpendicular to the axis of rotation A. The straight section 47 merges into a curved section 51 having radius R1 which, in turn, merges into a curved section 53 having a smaller radius R2 which merges into the axial cutting edge component 31 at the outer periphery P.

For purposes of comparison of the present invention with a conventional cutting tool, FIG. 6 schematically shows a cutting tool 121 with a cutting edge 129 at a working end of the cutting tool. The cutting tool 121 has a radius R, and a feed of R−Y. For a conventional cutting tool with cutting edges oriented along radial lines, i.e., α=0°, at feed R−Y, the length of the chip is also R−Y. In the inventive cutting tool, the cutting edge 129 is oriented at a non-zero angle to a radius and, at feed R−Y, the length of the chip is L″. L″ can be calculated as follows:

R²=L²+X² L=(R²−X²)^{1/2}

Y²=L′²+X² L′=(Y²−X²)^{1/2}

L=L′+L″ L″=L−L′=(R²−X²)^{1/2}−Y(Y²−X²)^{1/2}

sin α=X/R

Thus, if R=8 and Y=6, then, if the cutting edge is oriented at angles of, for example, α=18°, then X=2.48 and L″=2.19. If R=8 and Y=6, then, if the cutting edge is oriented at angles of, for example, α=31°, then X=4.12 where α=31° and L″=2.48. By contrast, in a conventional tool, where α=0°, the length of the chip will be 2. As a consequence, the larger the angle α is, the thinner the chips formed will be compared to a cutting tool operated at the same rotational speed and feed rate. In other words, if the feed for the cutting tool is the same, because the volume of the material removed by each cutting tool at the same feed is the same, the cutting edges that form longer chips, i.e., the cutting edges angled at α=18° or 31°, ordinarily form thinner chips.

By substantially the same logic, compared to a conventional cutting tool having the same diameter and number of cutting edges, the inventive cutting tool 121 forms chips having the same thickness as chips formed by the second cutting tool when the cutting tool is operated at the same rotational speed and a higher feed rate than the second cutting tool. In other words, instead of producing thinner chips at the same feed, the cutting tool 121 can produce the same size chips at a higher feed.

The cutting tool according to the present invention preferably relates to the field of non-drilling end milling cutters. The cutting tool has longer radial cutting edges radially outside of the circle C than hitherto known tools of the same diameter such that thinner chips are cut and higher feed rates can be used while maintaining tool life. Also, the geometrical configuration of the cutting tool according to the present invention allows the provision of more radial cutting edges than hitherto known tools of the same diameter such that even higher feed rates can be used.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

1. A cutting tool, having an axis of rotation and comprising:
a body having a working end; and
a plurality of cutting edges at the working end of the body, each cutting edge comprising a radial cutting edge component, wherein each radial cutting edge component is oriented at an angle to a radius extending from an axis of rotation of the tool, wherein interior ends of the cutting edges lie on common circle concentric with the axis of rotation, each said interior end of a cutting edge forming a tangent to the circle.

2. The cutting tool as set forth in claim 1, wherein the cutting edges are integrally formed with the body.

3. The cutting tool as set forth in claim 1, wherein each radial cutting edge component intersects with a corresponding radius at a circumferential periphery of the cutting tool.

4. The cutting tool as set forth in claim 3, wherein each radial cutting edge component leads its corresponding radius in a direction of rotation of the cutting tool.

5. The cutting tool as set forth in claim 1, wherein each cutting edge further comprises an axial cutting edge component extending in a generally axial direction of the cutting tool.

6. The cutting tool as set forth in claim 1, wherein an axial clearance surface follows at least a part of each axial cutting edge component in a direction of rotation of the cutting tool.

7. The cutting tool as set forth in claim 6, wherein, for each cutting edge, the axial clearance surface is non-perpendicular to the radius corresponding to the radial cutting edge component of the cutting edge.

8. The cutting tool as set forth in claim 6, wherein a radial clearance surface follows at least a part of each radial cutting edge component in a direction of rotation of the cutting tool.

9. The cutting tool as set forth in claim 1, wherein each cutting edge is straight when viewed along an axis of rotation of the cutting tool.

10. The cutting tool as set forth in claim 1, wherein straight lines extending along each cutting edge are each tangent to a common circle.

11. The cutting tool as set forth in claim 1, wherein at least a portion of each cutting edge is curved when viewed in a direction perpendicular to the cutting edge and perpendicular to the axis of rotation.

12. The cutting tool as set forth in claim 1, wherein, compared to a second cutting tool having the same diameter and number of cutting edges, the cutting tool forms thinner chips when operated at the same rotational speed and feed rate as the second cutting tool.

13. The cutting tool as set forth in claim 1, wherein, compared to a second cutting tool having the same diameter and number of cutting edges, the cutting tool forms chips having the same thickness as chips formed by the second cutting tool when the cutting tool is operated at the same rotational speed as and a higher feed rate than the second cutting tool.
